(19) United States
(12) Patent Application Publication
(10) Pub. No.: US 2026/0161786 A1
(43) Pub. Date: Jun. 11, 2026

(54) CYBER ATTACK LOG PROCESSING METHOD, ELECTRONIC DEVICE, AND STORAGE MEDIUM

(71) Applicant: Beijing Volcano Engine Technology Co., Ltd., Beijing (CN)

(72) Inventors: Yunpeng ZHANG, Beijing (CN); Yuanming HU, Beijing (CN); Ting CAI, Beijing (CN); Xiaodong SU, Beijing (CN); Heping JIANG, Beijing (CN)

(21) Appl. No.: 19/351,089

(22) Filed: Oct. 6, 2025

(30) Foreign Application Priority Data
Dec. 9, 2024 (CN) 202411805440.4

(51) Int. Cl. G06F 21/56

(52) U.S. Cl. CPC G06F 21/566; G06F 2221/034

(57) ABSTRACT

A cyber attack log processing method, an electronic device, and a storage medium are provided. The method includes: determining, for each attack log in the first attack log set, an attack type of the attack log according to the target attack mode corresponding to the attack log; and inputting, for each determined attack type, basic alarm information, interface information, and the target attack mode corresponding to each attack log belonging to the attack type in the first attack log set and a model prompt into a first large language model to obtain a first attack behavior analysis report corresponding to the attack type.

### CROSS-REFERENCE TO RELATED APPLICATION(S)

The present application claims priority to Chinese Patent Application No. 202411805440.4, filed on Dec. 9, 2024, which is incorporated herein by reference in its entirety as a part of the present application.

### TECHNICAL FIELD

The present disclosure relates to the field of data processing technologies.

### BACKGROUND

Cyber attack log analysis has always been a task that relies heavily on security operation. In particular, continuously detecting possible attack events from massive data is very complicated, time-consuming, labor-intensive, and boring. In addition, cyber attack log analysis requires senior engineers with considerable experience to detect relatively hidden attack events.

### SUMMARY

The Summary section is provided to briefly introduce the concepts, which will be described in detail later in the Detailed Description of Embodiments section. The contents described in this Summary section are not intended to identify essential features or necessary features of the embodiments of the present disclosure, nor is it intended to limit the scope of the present disclosure.

The present disclosure provides a cyber attack log processing method. The cyber attack log processing method includes:
obtaining a first attack log set;
determining basic alarm information and interface information of an attack target corresponding to each attack log in the first attack log set, and a target attack mode (for example, a first attack mode) of an attack event corresponding to each attack log in the first attack log set;
determining, for each attack log in the first attack log set, an attack type of the attack log according to the target attack mode corresponding to the attack log; and
inputting, for each determined attack type, basic alarm information, interface information, and the target attack mode corresponding to each attack log belonging to the attack type in the first attack log set and a model prompt into a first large language model to obtain a first attack behavior analysis report corresponding to the attack type, where the model prompt includes at least one of an attack analysis prompt, a danger analysis prompt, and an output style prompt, and the first attack behavior analysis report includes an attack behavior analysis result of at least one attack event of the attack type.

The present disclosure provides a computer-readable medium having a computer program stored thereon. When the computer program is executed by a processing apparatus, the steps of the cyber attack log processing method provided in the first aspect of the present disclosure are implemented.

The present disclosure provides an electronic device. The electronic device includes:
a storage apparatus having a computer program stored thereon; and
a processing apparatus configured to execute the computer program in the storage apparatus to implement the steps of the cyber attack log processing method provided in the present disclosure.

The present disclosure provides a computer program product including a computer program. When the computer program is executed by a processor, the steps of the cyber attack log processing method provided in the present disclosure are implemented.

Other features and advantages of the present disclosure will be described in detail in the following Detailed Description of Embodiments section.

### BRIEF DESCRIPTION OF DRAWINGS

The preceding and other features, advantages, and aspects of the embodiments of the present disclosure will become more apparent by referring to the following Detailed Description of Embodiments section and in conjunction with the drawings. Throughout the drawings, the same or similar reference numerals represent the same or similar elements. It should be understood that the drawings are schematic and that parts and elements are not necessarily drawn to scale. In the drawings:

FIG. 1 is a flowchart of a cyber attack log processing method according to an exemplary embodiment;

FIG. 2 is a flowchart of a cyber attack log processing method according to another exemplary embodiment;

FIG. 3 is a flowchart of a cyber attack log processing method according to yet another exemplary embodiment;

FIG. 4 is a flowchart of a cyber attack log processing method according to yet another exemplary embodiment;

FIG. 5 is a schematic diagram of a cyber attack log processing procedure according to an exemplary embodiment;

FIG. 6 is a block diagram of a cyber attack log processing apparatus according to an exemplary embodiment; and

FIG. 7 is a schematic structural diagram of an electronic device according to an exemplary embodiment.

### DETAILED DESCRIPTION

As discussed in the Background section, cyber attack log analysis relies heavily on security operation. In particular, continuously detecting possible attack events from massive data is very complicated, time-consuming, labor-intensive, and boring. To save operation manpower, in the related art, statistical aggregation analysis is usually performed based on fields of attack logs to form log aggregation results similar to events. However, the results formed based on statistics may only be aggregated around the fields of the logs, and it is difficult to associate a plurality of possible knowledge, making it difficult to detect hidden attack events. In addition, if it is necessary to further clarify the industry situation, the role of the attacked path, and the attack purpose, on the one hand, a huge knowledge base needs to be prepared, and at the same time, the statements that may be concatenated need to be carefully considered, otherwise the analysis results will be unreadable.

In view of this, the present disclosure provides a cyber attack log processing method, a medium, an electronic device, and a program product.

Hereinafter, embodiments of the present disclosure will be described in more detail with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for illustrative purposes and are not intended to limit the protection scope of the present disclosure.

It should be understood that steps described in method implementations of the present disclosure may be performed in different orders and/or in parallel. In addition, the method implementations may include additional steps and/or omit the execution of some shown steps. The scope of the present disclosure is not limited in this respect.

As used herein, the term “include/comprise” and its variants are open-ended inclusions, that is, “include/comprise but not limited to”. The term “based on” is “at least partially based on”. The term “an embodiment” means “at least one embodiment”. The term “another embodiment” means “at least one other embodiment”. The term “some embodiments” means “at least some embodiments”. Related definitions of other terms will be given in the following description.

It should be noted that concepts such as “first” and “second” mentioned in the present disclosure are only used to distinguish different apparatuses, modules, or units, and are not used to limit the order of or interdependence between the functions performed by these apparatuses, modules, or units.

It should be noted that modifications of “one” and “a plurality of” mentioned in the present disclosure are illustrative and not restrictive. Those skilled in the art should understand that unless otherwise clearly indicated in the context, they should be understood as “one or more”.

The names of messages or information exchanged between a plurality of apparatuses in the implementations of the present disclosure are for illustrative purposes only, and are not intended to limit the scope of the messages or information.

It may be understood that before the use of the technical schemes disclosed in the embodiments of the present disclosure, the user should be informed of the type, range of use, use scenarios, etc., of personal information involved in the present disclosure in an appropriate manner in accordance with relevant laws and regulations, and the authorization of the user should be obtained.

For example, in response to reception of an active request from a user, prompt information is sent to the user to clearly inform the user that the requested operation will require access to and use of the user's information. In this way, the user may independently choose, based on the prompt information, whether to provide the information to software or hardware, such as an electronic device, an application, a server, or a storage medium, that performs the operations of the technical schemes of the present disclosure.

As an optional but non-limiting implementation, in response to the reception of the active request from the user, the prompt information may be sent to the user in the form of, for example, a pop-up window, in which the prompt information may be presented in text. In addition, the pop-up window may also include a selection control for the user to choose whether to “agree” or “disagree” to provide the information to the electronic device.

It may be understood that the preceding process of notifying and obtaining user authorization is only illustrative and does not limit the implementations of the present disclosure. Other manners that satisfy the relevant laws and regulations may also be applied to the implementations of the present disclosure.

Meanwhile, it may be understood that the data involved in the technical schemes (including but not limited to the data itself, obtaining or use of the data) should comply with the requirements of corresponding laws, regulations, and related provisions.

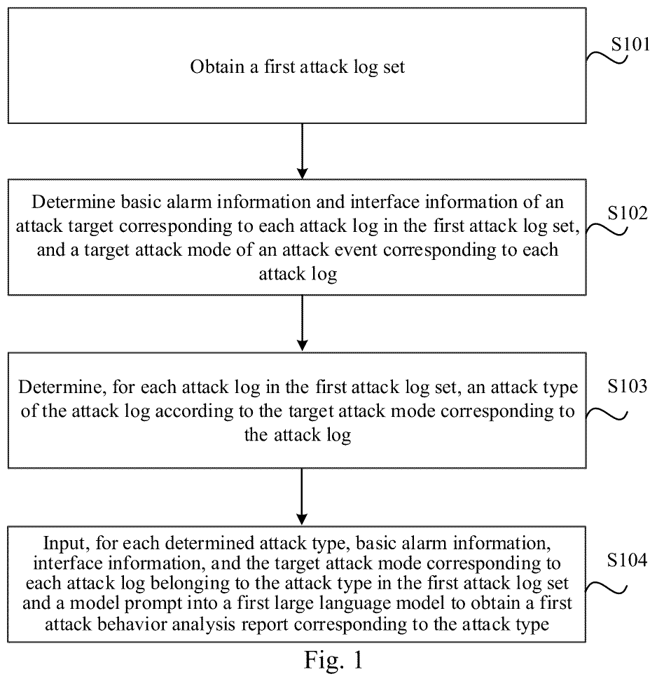

FIG. 1 is a flowchart of a cyber attack log processing method according to an exemplary embodiment. As shown in FIG. 1, the cyber attack log processing method may include the following steps S101 to S104.

In S101: obtaining a first attack log set obtained.

In the present disclosure, the first attack log set may be attack logs in any period of time. For example, the first attack logs are attack logs in a first period of time, where the first period of time is a period of time of a preset duration (for example, 1 hour) before the current moment.

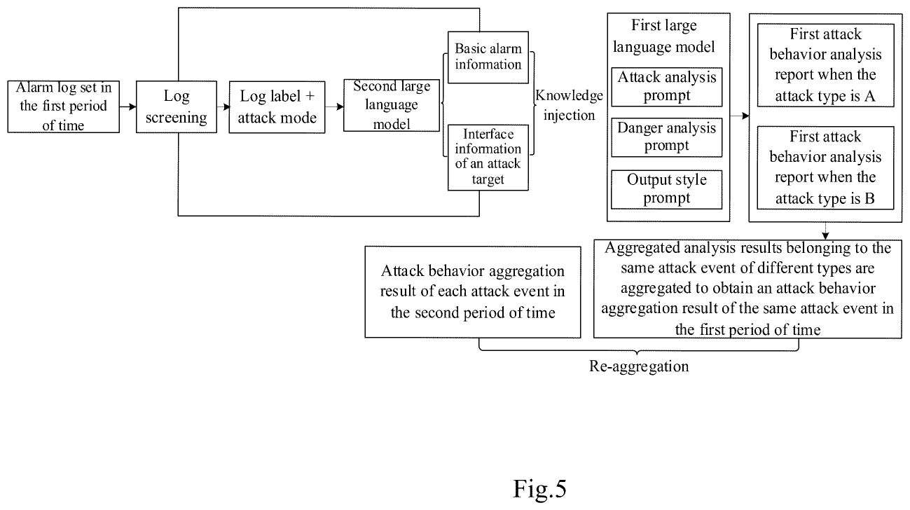

Specifically, as shown in FIG. 5, an alarm log set, for example, an alarm log set in the first period of time, may be obtained first, and then, deduplication processing is performed on the alarm log set, and at the same time, the number of occurrences of each alarm log is counted. Finally, attack logs are screened from the alarm logs obtained after the deduplication processing according to flag information of the alarm logs. The flag information is configured to represent whether the alarm log is an attack log. If the flag information of the alarm log represents that the alarm log is an attack log, it is determined that the alarm log belongs to an attack log; if the flag information of the alarm log represents that the alarm log is not an attack log, it is determined that the alarm log does not belong to an attack log.

In addition, when the deduplication processing is performed on the alarm log set, alarm logs with consistent field information may be determined as the same alarm log.

In S102: determining basic alarm information and interface information of an attack target corresponding to each attack log in the first attack log set, and a target attack mode of an attack event corresponding to each attack log.

In the present disclosure, the attack log may include the basic alarm information and the interface information of the attack target, and the basic alarm information and the interface information of the attack target of the attack log may be obtained by querying corresponding fields of the attack log. The basic alarm information may include address information of an attacker, a user agent (User Agent), an attack path, and other information.

The address information of the attacker may be, for example, an attack internet protocol (IP) address. The attack source IP refers to the IP address of the device that initiates the cyber attack, and this IP address is the network address used by the attacker to connect to the target system. By analyzing the attack source IP, the geographic origin of the attack, the possible attacker, and the attack pattern may be identified.

The User Agent information refers to an identity identification of a client (such as a browser or a crawler) that initiates a network request. In a hypertext transfer protocol (HTTP) request, a user agent character string is transmitted through a User-Agent request header field, and the User Agent information specifically includes information such as a browser type, a browser version, and an operating system. In security log analysis, the User Agent information may be used to identify and track the attack source and analyze the attack pattern.

The attack path refers to a series of steps and paths that the attacker takes from the initial attack point to the target system or asset.

The interface information of the attack target may include at least one of the following information:
an interface address, that is, a request uniform resource identifier (URL) of an application programming interface (API);
a request method, that is, a request type used by the attacker;
request parameters, including a path parameter, a query parameter, a request body, and the like; and
a response format, that is, a data format returned by the API.

The target attack mode of the attack event corresponding to the attack log refers to attack strategy description information of the attack event corresponding to the attack log. For example, the target attack mode of the attack event corresponding to the attack log is a remote code execute (RCE) attack.

In S103: determining, for each attack log in the first attack log set, an attack type of the attack log according to the target attack mode corresponding to the attack log.

In the present disclosure, the attack type may be, for example, a structured query language (SQL) injection attack, a cross site script (XSS) attack, an unauthorized access attack, an RCE attack, a file upload attack, a file inclusion attack, a weak password attack, vulnerability scanning, a WebShell attack, and the like.

In S104: inputting, for each determined attack type, basic alarm information, interface information, and the target attack mode corresponding to each attack log belonging to the attack type in the first attack log set and a model prompt into a first large language model to obtain a first attack behavior analysis report corresponding to the attack type.

In the present disclosure, after the attack type of each attack log in the first attack log set is determined through S103, the attack types to which these attack logs in the first attack log set belong may be known. Then, for each attack type of the attack types determined in S103, the first attack behavior analysis report corresponding to the attack type is generated using the first large language model, that is, aggregation analysis is performed on the attack logs in the dimension of the attack type using the first large language model to obtain the first attack behavior analysis reports corresponding to different attack types, respectively. The attack behavior analysis report is a report that analyzes cyber attack events and summarizes the attack type, the attack target, the attack means, the impact, the defense measures, and the like.

For example, as shown in FIG. 5, the attack logs in the first attack log set belong to two attack types, that is, an attack type A and an attack type B, that is, the determined attack types include the attack type A and the attack type B. The basic alarm information, the interface information, and the target attack mode corresponding to each attack log belonging to the attack type A in the first attack log set may be injected into the first large language model as knowledge to obtain the first attack behavior analysis report corresponding to the attack type A. Then, the basic alarm information, the interface information, and the target attack mode corresponding to each attack log belonging to the attack type B in the first attack log set are injected into the first large language model as knowledge to obtain the first attack behavior analysis report corresponding to the attack type B.

The model prompt may include at least one of an attack analysis prompt, a danger analysis prompt, and an output style prompt. The attack analysis prompt is configured to guide the first large language model to perform attack behavior analysis on the attack logs of a current attack type according to the basic alarm information, the interface information, and the target attack mode corresponding to each attack log belonging to the current attack type. The danger analysis prompt is configured to guide the first large language model to perform danger analysis on the attack logs of the current attack type according to the basic alarm information, the interface information, and the target attack mode corresponding to each attack log belonging to the current attack type. The output style prompt is configured to guide the first large language model to output according to a preset format, for example, an output result example is given.

As shown in FIG. 5, the model prompt includes the attack analysis prompt, the danger analysis prompt, and the output style prompt at the same time.

For example, the output style prompt is as follows:
[{‘attack type’:[‘WebShell attack’],
‘attack stage’:[‘attack execution’, ‘reconnaissance’],
‘attack start and end time’:[‘2024-07-09 01:08:03’, ‘2024-07-09 01:16:49’],
‘attack source’:{‘11.1.1.17’, ‘1.2.3.4’},
‘attack target’:{‘a’},
‘attack means analysis’:“Starting from 2024-07-09 01:08:03, the attacker uses the two IP addresses ‘11.1.1.17’ and ‘1.2.3.4’ to initiate a large number of requests for ‘a.b. com’ through user agents such as ‘ua1’ and ‘us2’. The attack mode includes a WebShell attack. The attack involves numerous interfaces, such as ‘interface 1’ and ‘interface 2’. By constructing specific request parameters, frequently accessing, carrying abnormal parameters and other techniques, the attacker attempts to execute remote code, detect vulnerabilities, obtain sensitive information, etc. The attack lasts until 2024-07-09 01:16:49.”,
‘attack purpose’:‘The purposes of the attacker include obtaining system control, stealing sensitive information, destroying system functions, preparing for further attacks, etc.’,
‘danger analysis’:‘These attack behaviors may lead to serious consequences such as complete control of the server, data theft, tampering or deletion, system function damage, service interruption, etc., which will have a great impact on the security and stability of the system.’}

The first attack behavior analysis report may include an attack behavior analysis result of at least one attack event of the attack type, where the attack behavior analysis result may include an attack means analysis result and a danger analysis result, and at least one of the attack type, an attack stage, attack start and end time, an attack source, the attack target, the attack purpose, the address information of the attacker, and the user agent information.

For example, the first attack behavior analysis report corresponding to the attack type “RCE attack” is as follows:
[{‘attack type’:[‘RCE attack’],
‘attack stage’:[‘attack execution’, ‘reconnaissance’],
‘attack start and end time’:[‘2023-06-09 11:03’, ‘2023-06-09 12:03’],
‘attack source’:{‘11.12.33.44’},
‘attack target’:{‘a1’},
‘attack means analysis’:“Starting from 2023-06-09 11:03, the attacker uses the IP address ‘11.12.33.44’ to initiate a large number of requests for ‘a1.b1.com’ through the user agent ‘ua12’. The attack mode includes an RCE attack. The attack involves ‘interface 12’, and by constructing specific request parameters, the attacker attempts to execute remote code, detect vulnerabilities, obtain sensitive information, etc. The attack lasts until 2023-06-09 12:03.”,
‘attack purpose’:‘The purposes of the attacker include stealing sensitive information, preparing for further attacks, etc.’,
‘danger analysis’:‘These attack behaviors may lead to serious consequences such as server data theft and system function damage, which will have a great impact on the security and stability of the system.’}]

In the preceding technical schemes, after the first attack log set is obtained, first, the basic alarm information corresponding to each attack log in the first attack log set, the interface information of the attack target of each attack log, and the target attack mode of the attack event corresponding to each attack log are determined. Then, for each attack log in the first attack log set, the attack type of the attack log is determined according to the target attack mode corresponding to the attack log. Finally, for each determined attack type, the basic alarm information, the interface information, and the target attack mode corresponding to each attack log belonging to the attack type in the first attack log set and the model prompt are input into the first large language model to obtain the first attack behavior analysis report corresponding to the attack type, where the model prompt includes at least one of the attack analysis prompt, the danger analysis prompt, and the output style prompt, and the first attack behavior analysis report includes the attack behavior analysis result of at least one attack event of the attack type. In this way, automatic aggregation analysis of cyber attack logs may be realized, thereby improving the efficiency of security operation and saving operation manpower. In addition, the large language model may be used to perform aggregation analysis on knowledge in a plurality of different dimensions such as the basic alarm information of the attack log, the interface information of the attack target, and the target attack mode of the corresponding attack event to associate the plurality of types of knowledge, so that hidden attack events may be more accurately discovered, the experience requirements of the enterprise security operation on operators may be alleviated, the working time and energy paid by the operators in security log analysis may be reduced, and readable attack behavior analysis reports may be output in a classification manner according to attack types. The cyber attack log processing method may be applied to various network firewalls, such as Web application firewalls and large model security firewalls.

Hereinafter, a specific implementation of determining the target attack mode of the attack event corresponding to each attack log in the first attack log set in S102 will be described in detail. Specifically, it may be implemented through the following steps (a1) and (a2).

Step (a1): for each attack log, current label information of the attack log is obtained.

In the present disclosure, the current label information is configured to represent a non-standard attack type of the attack event corresponding to the attack log. The attack log has label information (label) itself, where the label information is configured to represent the non-standard attack type of the attack event corresponding to the corresponding attack log, where the non-standard attack type is an attack mode designed according to a specific target or scenario. These attacks may not follow a standard classification, but are customized according to specific needs of the attacker and characteristics of the target environment. The non-standard attack type may be an attack type built in the attack log or customized by the user. For two attack logs of the same standard attack type, their label information may be different. The standard attack type refers to widely recognized and defined attack classifications, which are commonly used by the network security community to describe common attack patterns and behaviors. The following are common standard attack types: SQL injection attack, cross site script attack XSS, unauthorized access attack, RCE attack, file upload attack, file inclusion attack, weak password attack, vulnerability scanning, WebShell attack, etc.

Step (a2): an attack mode corresponding to the current label information is determined as the target attack mode of the attack event corresponding to the attack log according to a pre-established correspondence between label information and attack modes.

Hereinafter, a specific implementation of determining the attack type of the attack log according to the target attack mode corresponding to the attack log in S103 will be described in detail. Specifically, it may be implemented through the following steps (b1) and (b2).

Step (b1): the current label information of the attack log is obtained.

Step (b2): the target attack mode corresponding to the attack log and the current label information are input into a second large language model to obtain a standard attack type of the attack event corresponding to the attack log as the attack type of the attack log.

In the present disclosure, since the current label information of different attack logs is the non-standard attack type, in order to facilitate subsequent aggregation analysis of the attack logs according to the attack type, it is necessary to normalize the attack types of each attack log. Therefore, as shown in FIG. 5, the target attack mode corresponding to the attack log and the current label information (label) may be input into the second large language model to convert the non-standard attack type of the attack log into the standard attack type, so that standardization of the attack types of different attack logs may be realized through the second large language model. The output of the second large language model is one of a plurality of preset attack types, and these preset attack types are called standard attack types.

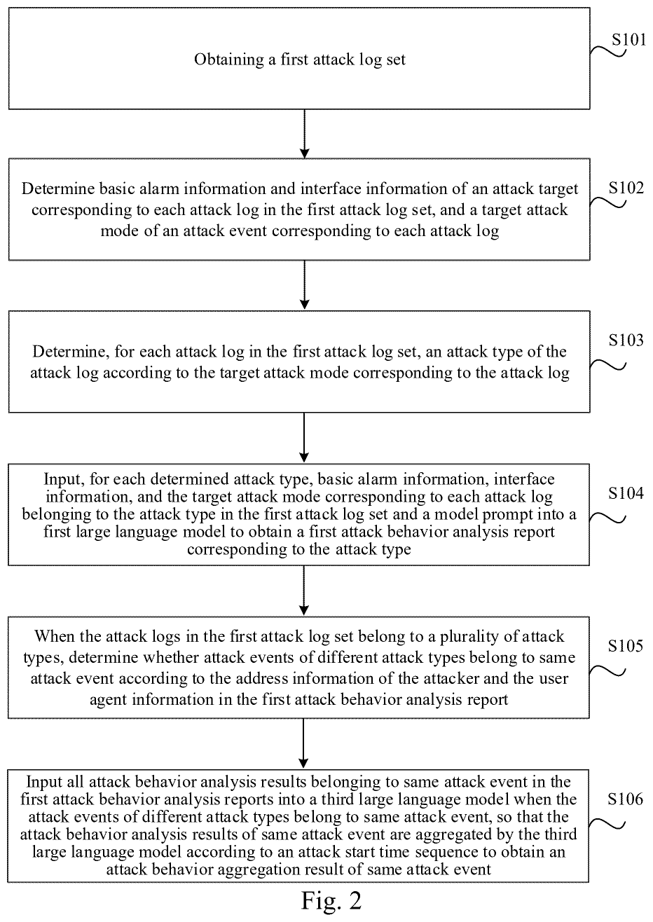

When implementing a complex attack, the attacker often adopts a plurality of attack types to achieve the attack purpose. In this way, the same attack event may use a plurality of attack types to implement the attack. Therefore, after aggregation analysis is performed on the attack logs in the dimension of the attack type using the first large language model to obtain the first attack behavior analysis reports corresponding to different attack types, respectively, as shown in FIG. 5, aggregation analysis results belonging to the same attack event of different attack types may be aggregated, that is, the first attack behavior analysis reports corresponding to different attack types are re-aggregated in the dimension of the attack event, and an attack behavior aggregation result of each attack event in a first period of time may be obtained. In this way, different attack behaviors may be associated, thereby gaining deep insight into the overall intention of the attacker. Specifically, as shown in FIG. 2, the preceding cyber attack log processing method may further include the following S105 and S106.

In S105: when the attack logs in the first attack log set belong to a plurality of attack types, determining whether attack events of different attack types belong to the same attack event according to address information of the attacker and user agent information in the first attack behavior analysis report.

In the present disclosure, the attack behavior analysis result of the attack event in the first attack behavior analysis report includes the address information of the attacker and the user agent information.

In an implementation, if the address information of the attackers of two attack events of different attack types is the same and the user agent information of the two attack events is the same, it is determined that the two attack events belong to the same attack event. If the address information of the attackers of two attack events of different attack types is different or the user agent information of the two attack events is different, it is determined that the two attack events do not belong to the same attack event.

In S106: inputting all attack behavior analysis results belonging to the same attack event in the first attack behavior analysis reports into a third large language model when the attack events of different attack types belong to the same attack event, so that the attack behavior analysis results of the same attack event are aggregated by the third large language model according to an attack start time sequence to obtain an attack behavior aggregation result of the same attack event.

Different attack behavior analysis results of the same attack event are aggregated by the third large language model according to the attack start time sequence, the attack behavior aggregation result of the same attack event may be obtained. At the same time, for an attack event involving only one attack type in the first attack behavior analysis report, the attack behavior analysis result of the attack event may be directly used as the attack behavior aggregation result of the attack event. In this way, the attack behavior aggregation result of each attack event in the first period of time may be obtained, which constitutes a second attack behavior analysis report in the first period of time. The second attack behavior analysis report includes the attack behavior aggregation result of each attack event in the corresponding period of time.

The attack behavior analysis results belonging to the same attack event of different attack types are sorted in the sequence of attack initiation time, which is convenient for clearly understanding the complete attack context of an attack event in the corresponding period of time, thereby gaining deep insight into the overall intention of the attacker.

For example, different attack behavior analysis results of the same attack event are aggregated by the third large language model according to the attack start time sequence, and the obtained attack behavior aggregation result of the same attack event is as follows:
[{‘attack type’:[‘WebShell attack’,
‘unauthorized access attack’,
‘XSS cross site script attack’,
‘RCE remote code execute attack’,
‘multiple attack types (file traversal, path traversal, local file inclusion)’,
‘vulnerability scanning’],
‘attack stage’:[‘attack execution’, ‘reconnaissance’],
‘attack start and end time’:[‘2024-07-09 01:08:03’, ‘2024-07-09 01:16:49’],
‘attack source’:{‘11.11.11.11, ‘22.22.22.22’},
‘attack target’:{‘b1’,
‘b2’,
‘b3’,
‘b4’,
‘b5’},
‘attack means analysis’:“Starting from 2024-07-09 01:08:03, the attacker uses the two IP addresses ‘11.11.11.11’ and ‘22.22.22.22’ to initiate a large number of requests for ‘s.b.com’ through user agents such as ‘ua22’ and ‘ua24’. The attack modes include an RCE remote code execute attack, vulnerability scanning, multiple attack types (file traversal, path traversal, local file inclusion), an unauthorized access attack, an XSS cross site script attack, a WebShell attack, etc. The attack involves numerous interfaces, such as ‘interface 4’ and ‘interface 5’. By constructing specific request parameters, frequently accessing, carrying abnormal parameters and other techniques, the attacker attempts to execute remote code, detect vulnerabilities, obtain sensitive information, etc. The attack lasts until 2024-07-09 01:16:49.”,
‘attack purpose’:‘The purposes of the attacker include obtaining system control, stealing sensitive information, destroying system functions, preparing for further attacks, etc.’,
‘danger analysis’:‘These attack behaviors may lead to serious consequences such as complete control of the server, data theft, tampering or deletion, system function damage, service interruption, etc., which will have a great impact on the security and stability of the system.’}]

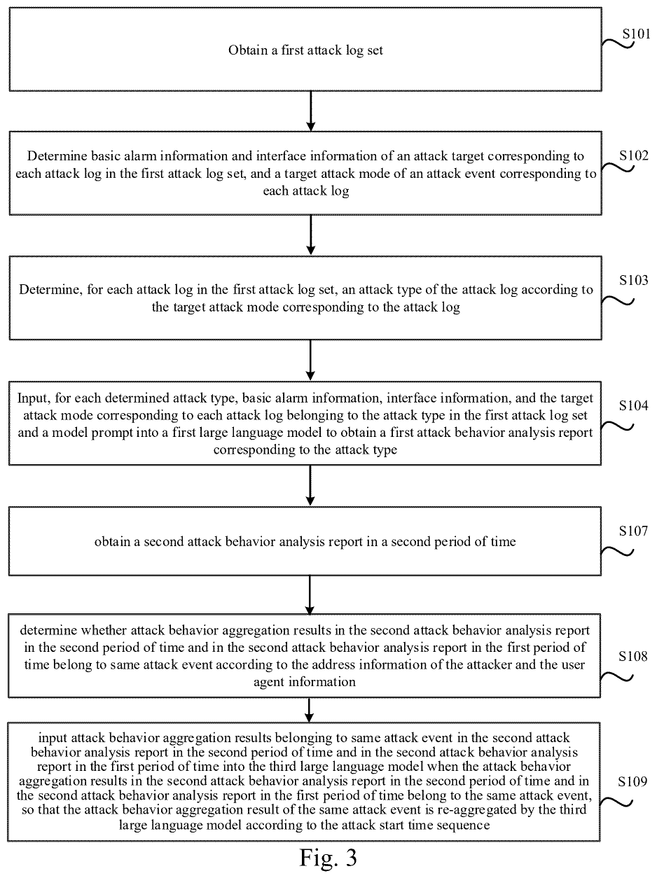

In order to prevent running slowly caused by excessive log accumulation and interpretation at one time, ensure a certain degree of real-time performance, and prevent long-term latent attack events from being difficult to detect due to relatively short log sampling, the steps of the preceding cyber attack log processing method may be executed every preset duration, that is, the preset duration is used as a method execution period. An attack event may span a plurality of execution periods. In order to gain a deeper insight into the overall intention of the attacker, as shown in FIG. 5, after the second attack behavior analysis report in the first period of time is obtained, it may be re-aggregated with the second attack behavior analysis report in the previous period of time. Specifically, as shown in FIG. 3, the preceding cyber attack log processing method may further include the following S107 to S109.

In S107: obtaining a second attack behavior analysis report in a second period of time.

In the present disclosure, the first attack log set includes attack logs in the first period of time, the first period of time is a period of time of a preset duration before the current moment, the second period of time is a period of time before the first period of time, and the steps of the cyber attack log processing method are executed every preset duration. The second attack behavior analysis report in the second period of time may include the attack behavior aggregation result of each attack event in the second period of time.

In S108: determining whether attack behavior aggregation results in the second attack behavior analysis report in the second period of time and in the second attack behavior analysis report in the first period of time belong to the same attack event according to the address information of the attacker and the user agent information.

Specifically, if there are attack behavior aggregation results with the same address information of the attacker and the same user agent information in the attack behavior aggregation result in the first period of time and the attack behavior aggregation result in the second period of time, it is determined that the two attack behavior aggregation results belong to the same attack event.

In S109: inputting attack behavior aggregation results belonging to the same attack event in the second attack behavior analysis report in the second period of time and in the second attack behavior analysis report in the first period of time into the third large language model when the attack behavior aggregation results in the second attack behavior analysis report in the second period of time and in the second attack behavior analysis report in the first period of time belong to the same attack event, so that the attack behavior aggregation result of the same attack event is re-aggregated by the third large language model according to the attack start time sequence.

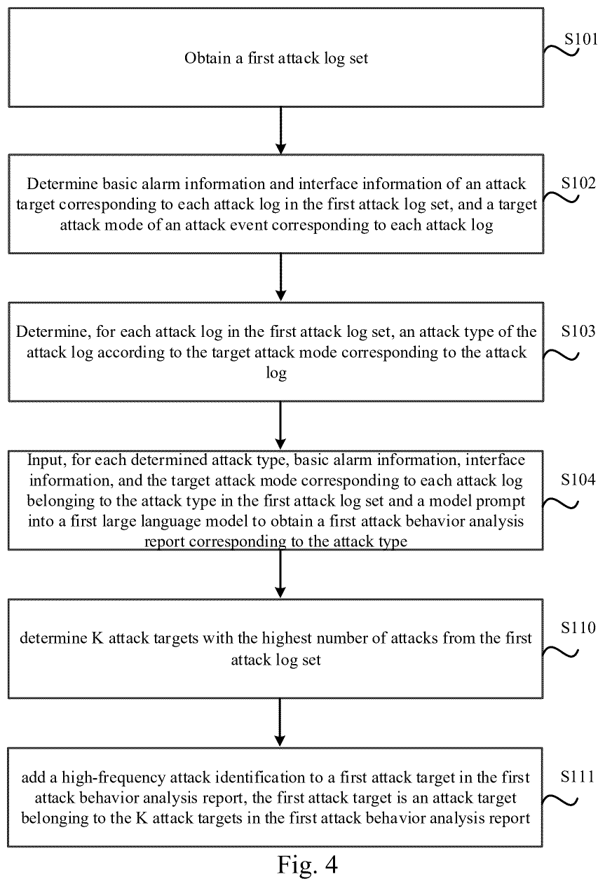

FIG. 4 is a flowchart of a cyber attack log processing method according to yet another exemplary embodiment. As shown in FIG. 4, the preceding cyber attack log processing method may further include S110 and S111.

In S110: determining K attack targets with the highest number of attacks from the first attack log set.

In the present disclosure, K≥1. After the first attack log set is obtained, the number of occurrences of addresses with different attack purposes may be determined according to the number of occurrences of each attack log counted during the deduplication processing of the alarm log set, and attack targets corresponding to the K attack purpose addresses with the largest number of occurrences are determined as the K attack targets with the highest number of attacks.

In S111: adding a high-frequency attack identification to a first attack target in the first attack behavior analysis report, and the first attack target is an attack target belonging to the K attack targets in the first attack behavior analysis report.

In the present disclosure, the high-frequency attack identification is added to the K attack targets with the highest number of attacks in the first attack behavior analysis report, which is convenient to directly know the targets that are often attacked through the analysis report.

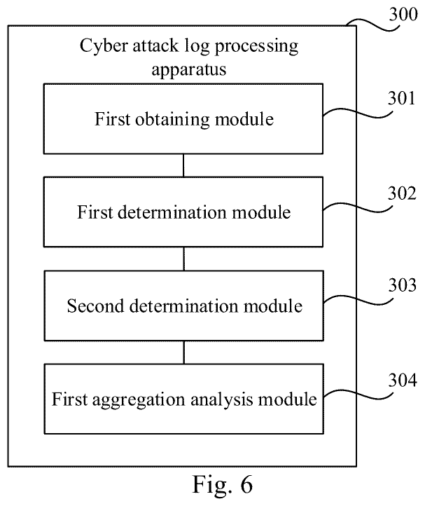

FIG. 6 is a block diagram of a cyber attack log processing apparatus according to an exemplary embodiment. As shown in FIG. 6, the cyber attack log processing apparatus 300 includes:
a first obtaining module 301 configured to obtain a first attack log set;
a first determination module 302 configured to determine basic alarm information corresponding to each attack log in the first attack log set, interface information of an attack target of each attack log, and a target attack mode of an attack event corresponding to each attack log;
a second determination module 303 configured to determine, for each attack log in the first attack log set, an attack type of the attack log according to the target attack mode corresponding to the attack log; and
a first aggregation analysis module 304 configured to input, for each determined attack type, basic alarm information, interface information, and a target attack mode corresponding to each attack log belonging to the attack type in the first attack log set and a model prompt into a first large language model to obtain a first attack behavior analysis report corresponding to the attack type, where the model prompt includes at least one of an attack analysis prompt, a danger analysis prompt, and an output style prompt, and the first attack behavior analysis report includes an attack behavior analysis result of at least one attack event of the attack type.

In the preceding technical schemes, after the first attack log set is obtained, first, the basic alarm information corresponding to each attack log in the first attack log set, the interface information of the attack target of each attack log, and the target attack mode of the attack event corresponding to each attack log are determined. Then, for each attack log in the first attack log set, the attack type of the attack log is determined according to the target attack mode corresponding to the attack log. Finally, for each determined attack type, the basic alarm information, the interface information, and the target attack mode corresponding to each attack log belonging to the attack type in the first attack log set and the model prompt are input into the first large language model to obtain the first attack behavior analysis report corresponding to the attack type, where the model prompt includes at least one of the attack analysis prompt, the danger analysis prompt, and the output style prompt, and the first attack behavior analysis report includes the attack behavior analysis result of at least one attack event of the attack type. In this way, automatic aggregation analysis of cyber attack logs may be realized, thereby improving the efficiency of security operation and saving operation manpower. In addition, the large language model may be used to perform aggregation analysis on knowledge in a plurality of different dimensions such as the basic alarm information of the attack log, the interface information of the attack target, and the target attack mode of the corresponding attack event to associate the plurality of types of knowledge, so that hidden attack events may be more accurately discovered, the experience requirements of the enterprise security operation on operators may be alleviated, the working time and energy paid by the operators in security log analysis may be reduced, and readable attack behavior analysis reports may be output in a classification manner according to attack types. The cyber attack log processing method may be applied to various network firewalls, such as Web application firewalls and large model security firewalls.

Optionally, the first determination module 302 includes:
a first obtaining sub-module configured to obtain, for each attack log, current label information of the attack log, where the current label information is configured to represent a non-standard attack type of the attack event corresponding to the attack log; and
a first determination sub-module configured to determine an attack mode corresponding to the current label information as the target attack mode of the attack event corresponding to the attack log according to a pre-established correspondence between label information and attack modes.

Optionally, the second determination module 303 includes:
a second obtaining sub-module configured to obtain current label information of the attack log, where the current label information is configured to represent a non-standard attack type of the attack event corresponding to the attack log; and
a classification sub-module configured to input the target attack mode corresponding to the attack log and the current label information into a second large language model to obtain a standard attack type of the attack event corresponding to the attack log as the attack type of the attack log.

Optionally, the attack behavior analysis result includes address information of an attacker and user agent information.

When the attack logs in the first attack log set belong to a plurality of attack types, the cyber attack log processing apparatus 300 further includes:
a third determination module configured to determine whether attack events of different attack types belong to the same attack event according to the address information of the attacker and the user agent information in the first attack behavior analysis report; and
a second aggregation analysis module configured to input attack behavior analysis results belonging to the same attack event in all first attack behavior analysis reports into a third large language model if the attack events of different attack types belong to the same attack event, so that the attack behavior analysis results of the same attack event are aggregated by the third large language model according to an attack start time sequence to obtain an attack behavior aggregation result of the same attack event.

Optionally, the cyber attack log processing apparatus 300 further includes:
a second obtaining module configured to obtain a second attack behavior analysis report in a second period of time, where the first attack log set includes attack logs in a first period of time, the first period of time is a period of time of a preset duration before the current moment, the second period of time is a period of time before the first period of time, the steps of the cyber attack log processing method are executed every preset duration, and the second attack behavior analysis report includes an attack behavior aggregation result of each attack event in the corresponding period of time;
a fourth determination module configured to determine whether attack behavior aggregation results in the second attack behavior analysis report in the second period of time and the second attack behavior analysis report in the first period of time belong to the same attack event according to the address information of the attacker and the user agent information; and
a third aggregation analysis module configured to input attack behavior aggregation results belonging to the same attack event in the second attack behavior analysis report in the second period of time and the second attack behavior analysis report in the first period of time into the third large language model if the attack behavior aggregation results in the second attack behavior analysis report in the second period of time and the second attack behavior analysis report in the first period of time belong to the same attack event, so that the attack behavior aggregation result of the same attack event is re-aggregated by the third large language model according to the attack start time sequence.

Optionally, the cyber attack log processing apparatus 300 further includes:
a fifth determination module configured to determine K attack targets with the highest number of attacks from the first attack log set, where K≥1; and
an adding module configured to add a high-frequency attack identification to a first attack target in the first attack behavior analysis report, where the first attack target is an attack target belonging to the K attack targets in the first attack behavior analysis report.

Optionally, the attack behavior analysis result includes an attack means analysis result and a danger analysis result, and at least one of an attack type, an attack stage, attack start and end time, an attack source, an attack target, and an attack purpose.

The present disclosure further provides a computer-readable medium having a computer program stored thereon. When the computer program is executed by a processing apparatus, the steps of the cyber attack log processing method provided in the present disclosure are implemented.

The present disclosure further provides an electronic device. The electronic device includes:
a storage apparatus having a computer program stored thereon; and
a processing apparatus configured to execute the computer program in the storage apparatus to implement the steps of the cyber attack log processing method provided in the present disclosure.

The present disclosure further provides a computer program product including a computer program. When the computer program is executed by a processor, the steps of the cyber attack log processing method provided in the present disclosure are implemented.

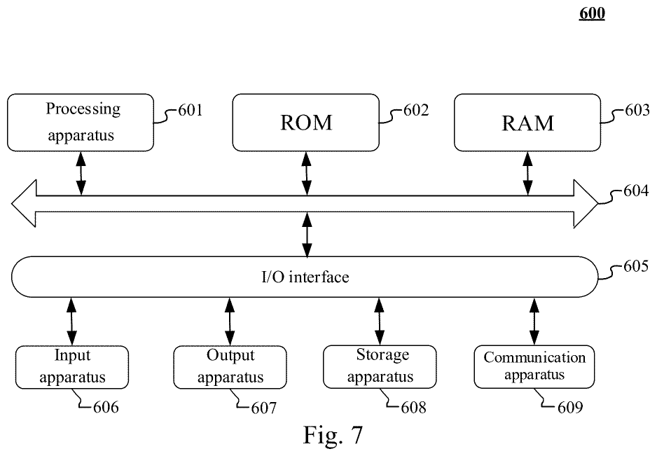

Reference is made to FIG. 7 below, which illustrates a schematic diagram of a structure of an electronic device (e.g., a terminal device or a server) 600 suitable for implementing the embodiments of the present disclosure. The terminal device in the embodiments of the present disclosure may include, but is not limited to, mobile terminals such as mobile phones, notebook computers, digital broadcast receivers, personal digital assistants (PDAs), tablet computer, portable media players (PMPs), and vehicle terminals (e.g., vehicle navigation terminals), and fixed terminals such as digital TVs and desktop computers. The electronic device shown in FIG. 7 is only an example and should not impose any limitation on the function and scope of use of the embodiments of the present disclosure.

As shown in FIG. 7, the electronic device 600 may include a processing apparatus (such as a central processing unit and a graphics processing unit) 601, which may perform various appropriate actions and processes according to a program stored in a read-only memory (ROM) 602 or a program loaded from a storage apparatus 608 into a random access memory (RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatuses may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a magnetic tape and a hard disk; and a communication apparatus 609. The communication apparatus 609 may allow the electronic device 600 to be in wireless or wired communication with other devices to exchange data. Although FIG. 7 shows the electronic device 600 having various apparatuses, it should be understood that it is not necessary to implement or provide all of the illustrated apparatuses. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program contains program code for executing the method shown in the flowchart. In such an embodiment, the computer program may be downloaded online through the communication apparatus 609 and installed, or installed from the storage apparatus 608, or installed from the ROM 602. When the computer program is executed by the processing apparatus 601, the preceding functions defined in the method of the embodiments of the present disclosure are executed.

It should be noted that the computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. In the present disclosure, the computer-readable signal medium may include a data signal propagated on a baseband or as a part of a carrier, and computer-readable program code is carried thereon. The data signal propagated in this manner may be in a plurality of forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted in any suitable medium, including but not limited to a wire, an optical cable, a radio frequency (RF), or any suitable combination thereof.

In some implementations, the client and the server may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device or may exist alone without being assembled into the electronic device.

The computer-readable medium carries one or more programs, which, when executed by the electronic device, cause the electronic device to: obtain a first attack log set; determine basic alarm information corresponding to each attack log in the first attack log set, interface information of an attack target of each attack log, and a target attack mode of an attack event corresponding to each attack log; determine, for each attack log in the first attack log set, an attack type of the attack log according to the target attack mode corresponding to the attack log; and input, for each determined attack type, basic alarm information, interface information, and a target attack mode corresponding to each attack log belonging to the attack type in the first attack log set and a model prompt into a first large language model to obtain a first attack behavior analysis report corresponding to the attack type, where the model prompt includes at least one of an attack analysis prompt, a danger analysis prompt, and an output style prompt, and the first attack behavior analysis report includes an attack behavior analysis result of at least one attack event of the attack type.

The computer program code for performing the operations of the present disclosure may be written in one or more programming languages or a combination thereof, where the programming languages include, but are not limited to, object-oriented programming languages such as Java, Smalltalk, and C++, and further include conventional procedural programming languages such as “C” language or similar programming languages. The program code may be completely executed on a user computer, partially executed on a user computer, executed as an independent software package, partially executed on a user computer and partially executed on a remote computer, or completely executed on a remote computer or server. In the case involving the remote computer, the remote computer may be connected to the user computer through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or by a combination of dedicated hardware and computer instructions.

The modules involved in the embodiments of the present disclosure may be implemented by software or by hardware. The name of a module does not constitute a limitation on the module itself under certain circumstances. For example, the first obtaining module may also be described as “a module for obtaining a first attack log set”.

The functions described above may be performed at least partially by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the preceding. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the preceding.

According to one or more embodiments of the present disclosure, example one provides a cyber attack log processing method. The cyber attack log processing method includes:
obtaining a first attack log set;
determining basic alarm information corresponding to each attack log in the first attack log set, interface information of an attack target of each attack log, and a target attack mode of an attack event corresponding to each attack log;
determining, for each attack log in the first attack log set, an attack type of the attack log according to the target attack mode corresponding to the attack log; and
inputting, for each determined attack type, basic alarm information, interface information, and a target attack mode corresponding to each attack log belonging to the attack type in the first attack log set and a model prompt into a first large language model to obtain a first attack behavior analysis report corresponding to the attack type, where the model prompt includes at least one of an attack analysis prompt, a danger analysis prompt, and an output style prompt, and the first attack behavior analysis report includes an attack behavior analysis result of at least one attack event of the attack type.

According to one or more embodiments of the present disclosure, example two provides the cyber attack log processing method of example one. The determining the target attack mode of the attack event corresponding to each attack log in the first attack log set includes:
obtaining, for each attack log, current label information of the attack log, where the current label information is configured to represent a non-standard attack type of the attack event corresponding to the attack log; and
determining an attack mode corresponding to the current label information as the target attack mode of the attack event corresponding to the attack log according to a pre-established correspondence between label information and attack modes.

According to one or more embodiments of the present disclosure, example three provides the cyber attack log processing method of example one. The determining the attack type of the attack log according to the target attack mode corresponding to the attack log includes:
obtaining current label information of the attack log, where the current label information is configured to represent a non-standard attack type of the attack event corresponding to the attack log; and
inputting the target attack mode corresponding to the attack log and the current label information into a second large language model to obtain a standard attack type of the attack event corresponding to the attack log as the attack type of the attack log.

According to one or more embodiments of the present disclosure, example four provides the cyber attack log processing method of example one. The attack behavior analysis result includes address information of an attacker and user agent information.

When the attack logs in the first attack log set belong to a plurality of attack types, the cyber attack log processing method further includes:
determining whether attack events of different attack types belong to the same attack event according to the address information of the attacker and the user agent information in the first attack behavior analysis report; and
inputting attack behavior analysis results belonging to the same attack event in all first attack behavior analysis reports into a third large language model if the attack events of different attack types belong to the same attack event, so that the attack behavior analysis results of the same attack event are aggregated by the third large language model according to an attack start time sequence to obtain an attack behavior aggregation result of the same attack event.

According to one or more embodiments of the present disclosure, example five provides the cyber attack log processing method of example four. The cyber attack log processing method further includes:
obtaining a second attack behavior analysis report in a second period of time, where the first attack log set includes attack logs in a first period of time, the first period of time is a period of time of a preset duration before the current moment, the second period of time is a period of time before the first period of time, the steps of the cyber attack log processing method are executed every preset duration, and the second attack behavior analysis report includes an attack behavior aggregation result of each attack event in the corresponding period of time;
determining whether attack behavior aggregation results in the second attack behavior analysis report in the second period of time and the second attack behavior analysis report in the first period of time belong to the same attack event according to the address information of the attacker and the user agent information; and
inputting attack behavior aggregation results belonging to the same attack event in the second attack behavior analysis report in the second period of time and the second attack behavior analysis report in the first period of time into the third large language model if the attack behavior aggregation results in the second attack behavior analysis report in the second period of time and the second attack behavior analysis report in the first period of time belong to the same attack event, so that the attack behavior aggregation result of the same attack event is re-aggregated by the third large language model according to the attack start time sequence.

According to one or more embodiments of the present disclosure, example six provides the cyber attack log processing method of any one of examples one to four. The cyber attack log processing method further includes:
determining K attack targets with the highest number of attacks from the first attack log set, where K≥1; and
adding a high-frequency attack identification to a first attack target in the first attack behavior analysis report, where the first attack target is an attack target belonging to the K attack targets in the first attack behavior analysis report.

According to one or more embodiments of the present disclosure, example seven provides the cyber attack log processing method of any one of examples one to four. The attack behavior analysis result includes an attack means analysis result and a danger analysis result, and at least one of an attack type, an attack stage, attack start and end time, an attack source, an attack target, and an attack purpose.

According to one or more embodiments of the present disclosure, example eight provides a computer-readable medium having a computer program stored thereon. When the computer program is executed by a processing apparatus, the steps of the cyber attack log processing method of any one of examples one to seven are implemented.

According to one or more embodiments of the present disclosure, example nine provides an electronic device. The electronic device includes:
a storage apparatus having a computer program stored thereon; and
a processing apparatus configured to execute the computer program in the storage apparatus to implement the steps of the cyber attack log processing method of any one of examples one to seven.

According to one or more embodiments of the present disclosure, example ten provides a computer program product including a computer program. When the computer program is executed by a processor, the steps of the cyber attack log processing method of any one of examples one to seven are implemented.

The preceding description only illustrates preferred embodiments of the present disclosure and applied technical principles. Those skilled in the art should understand that the disclosed scope involved in the present disclosure is not limited to the technical schemes formed by the specific combination of the preceding technical features, and should also cover other technical schemes formed by any combination of the preceding technical features or their equivalent features without departing from the preceding disclosed concept. For example, the preceding features and the technical features provided in the present disclosure (but not limited to) with similar functions may be replaced each other to form a technical scheme.

In addition, although the operations are depicted in a particular order, it should not be understood as requiring the operations to be performed in the shown particular order or in a sequential order. Under certain circumstances, multitasking and parallel processing may be advantageous. Similarly, although the preceding discussion contains a number of specific implementation details, these should not be construed as limiting the scope of the present disclosure. Certain features described in the context of separate embodiments may also be implemented in a single embodiment in combination. On the contrary, various features described in the context of a single embodiment may also be implemented in a plurality of embodiments individually or in any suitable sub-combination.

Although the subject matter has been described in terms specific to the structural features and/or method logic actions, it should be understood that the subject matter defined in the appended claims is not necessarily limited to the specific features or actions described above. On the contrary, the specific features and actions described above are only exemplary forms of implementing the claims. With respect to the apparatuses in the preceding embodiments, the specific manner in which each module performs an operation has been described in detail in the method embodiments, and will not be detailed herein.

1. A cyber attack log processing method, comprising:
obtaining a first attack log set;
determining basic alarm information and interface information of an attack target corresponding to each attack log in the first attack log set, and a first attack mode of an attack event corresponding to each attack log in the first attack log set;
determining, for each attack log in the first attack log set, an attack type of the attack log according to the first attack mode corresponding to the attack log; and
inputting, for each determined attack type, basic alarm information, interface information, and the first attack mode corresponding to each attack log belonging to the attack type in the first attack log set and a model prompt into a first large language model to obtain a first attack behavior analysis report corresponding to the attack type,
wherein the model prompt comprises at least one of an attack analysis prompt, a danger analysis prompt, or an output style prompt; and
the first attack behavior analysis report comprises an attack behavior analysis result of at least one attack event of the attack type.

2. The cyber attack log processing method of claim 1, wherein determining the first attack mode of the attack event corresponding to each attack log in the first attack log set comprises:
obtaining, for each attack log, current label information of the attack log, wherein the current label information is configured to represent a non-standard attack type of the attack event corresponding to the attack log; and
determining an attack mode corresponding to the current label information as the first attack mode of the attack event corresponding to the attack log according to a pre-established correspondence between label information and attack modes.

3. The cyber attack log processing method of claim 1, wherein determining the attack type of the attack log according to the first attack mode corresponding to the attack log comprises:
obtaining current label information of the attack log, wherein the current label information is configured to represent a non-standard attack type of the attack event corresponding to the attack log; and
inputting the first attack mode corresponding to the attack log and the current label information into a second large language model to obtain a standard attack type of the attack event corresponding to the attack log as the attack type of the attack log.

4. The cyber attack log processing method of claim 1, wherein the attack behavior analysis result comprises address information of an attacker and user agent information; and
when the attack logs in the first attack log set belong to a plurality of attack types, the cyber attack log processing method further comprises:
determining whether attack events of different attack types belong to same attack event according to the address information of the attacker and the user agent information in the first attack behavior analysis report; and
inputting all attack behavior analysis results belonging to same attack event in the first attack behavior analysis reports into a third large language model when the attack events of different attack types belong to same attack event, so that the attack behavior analysis results of same attack event are aggregated by the third large language model according to an attack start time sequence to obtain an attack behavior aggregation result of same attack event.

5. The cyber attack log processing method of claim 4, wherein the cyber attack log processing method further comprises:
obtaining a second attack behavior analysis report in a second period of time, wherein the first attack log set comprises attack logs in a first period of time, the first period of time is a period of time of a preset duration before the current moment, the second period of time is a period of time before the first period of time, the steps of the cyber attack log processing method are executed every preset duration, and the second attack behavior analysis report comprises an attack behavior aggregation result of each attack event in corresponding period of time;
determining whether attack behavior aggregation results in the second attack behavior analysis report in the second period of time and in the second attack behavior analysis report in the first period of time belong to same attack event according to the address information of the attacker and the user agent information; and
inputting attack behavior aggregation results belonging to same attack event in the second attack behavior analysis report in the second period of time and in the second attack behavior analysis report in the first period of time into the third large language model when the attack behavior aggregation results in the second attack behavior analysis report in the second period of time and in the second attack behavior analysis report in the first period of time belong to the same attack event, so that the attack behavior aggregation result of the same attack event is re-aggregated by the third large language model according to the attack start time sequence.

6. The cyber attack log processing method of claim 1, further comprising:
determining K attack targets with the highest number of attacks from the first attack log set, wherein K≥1; and
adding a high-frequency attack identification to a first attack target in the first attack behavior analysis report, wherein the first attack target is an attack target belonging to the K attack targets in the first attack behavior analysis report.

7. The cyber attack log processing method of claim 1, wherein the attack behavior analysis result comprises an attack means analysis result and a danger analysis result, and at least one of an attack type, an attack stage, attack start and end time, an attack source, an attack target, or an attack purpose.

8. A computer-readable medium, wherein the computer-readable medium having a computer program stored thereon, the computer program, when executed by at least one processing apparatus, causes a cyber attack log processing method to be performed, the cyber attack log processing method comprises:
obtaining a first attack log set;
determining basic alarm information and interface information of an attack target corresponding to each attack log in the first attack log set, and a first attack mode of an attack event corresponding to each attack log in the first attack log set;
determining, for each attack log in the first attack log set, an attack type of the attack log according to the first attack mode corresponding to the attack log; and
inputting, for each determined attack type, basic alarm information, interface information, and the first attack mode corresponding to each attack log belonging to the attack type in the first attack log set and a model prompt into a first large language model to obtain a first attack behavior analysis report corresponding to the attack type, wherein the model prompt comprises at least one of an attack analysis prompt, a danger analysis prompt, or an output style prompt, and the first attack behavior analysis report comprises an attack behavior analysis result of at least one attack event of the attack type.

9. The computer-readable medium of claim 8, wherein determining the first attack mode of the attack event corresponding to each attack log in the first attack log set comprises:
obtaining, for each attack log, current label information of the attack log, wherein the current label information is configured to represent a non-standard attack type of the attack event corresponding to the attack log; and
determining an attack mode corresponding to the current label information as the first attack mode of the attack event corresponding to the attack log according to a pre-established correspondence between label information and attack modes.

10. The computer-readable medium of claim 8, wherein determining the attack type of the attack log according to the first attack mode corresponding to the attack log comprises:
obtaining current label information of the attack log, wherein the current label information is configured to represent a non-standard attack type of the attack event corresponding to the attack log; and
inputting the first attack mode corresponding to the attack log and the current label information into a second large language model to obtain a standard attack type of the attack event corresponding to the attack log as the attack type of the attack log.

11. The computer-readable medium of claim 8, wherein the attack behavior analysis result comprises address information of an attacker and user agent information; and
when the attack logs in the first attack log set belong to a plurality of attack types, the cyber attack log processing method further comprises:
determining whether attack events of different attack types belong to same attack event according to the address information of the attacker and the user agent information in the first attack behavior analysis report; and
inputting all attack behavior analysis results belonging to same attack event in the first attack behavior analysis reports into a third large language model when the attack events of different attack types belong to same attack event, so that the attack behavior analysis results of same attack event are aggregated by the third large language model according to an attack start time sequence to obtain an attack behavior aggregation result of same attack event.

12. The computer-readable medium of claim 11, wherein the processing apparatus is further configured to:
obtain a second attack behavior analysis report in a second period of time, wherein the first attack log set comprises attack logs in a first period of time, the first period of time is a period of time of a preset duration before the current moment, the second period of time is a period of time before the first period of time, the steps of the cyber attack log processing method are executed every preset duration, and the second attack behavior analysis report comprises an attack behavior aggregation result of each attack event in corresponding period of time;
determine whether attack behavior aggregation results in the second attack behavior analysis report in the second period of time and in the second attack behavior analysis report in the first period of time belong to same attack event according to the address information of the attacker and the user agent information; and
input attack behavior aggregation results belonging to same attack event in the second attack behavior analysis report in the second period of time and in the second attack behavior analysis report in the first period of time into the third large language model when the attack behavior aggregation results in the second attack behavior analysis report in the second period of time and in the second attack behavior analysis report in the first period of time belong to the same attack event, so that the attack behavior aggregation result of the same attack event is re-aggregated by the third large language model according to the attack start time sequence.

13. The computer-readable medium of claim 8, wherein the processing apparatus is further configured to:
determine K attack targets with the highest number of attacks from the first attack log set, wherein K≥1; and
add a high-frequency attack identification to a first attack target in the first attack behavior analysis report, wherein the first attack target is an attack target belonging to the K attack targets in the first attack behavior analysis report.

14. An electronic device, comprising:
a storage apparatus having a computer program stored thereon; and
at least one processing apparatus configured to execute the computer program in the storage apparatus to implement a cyber attack log processing method, wherein the cyber attack log processing method comprises:
obtaining a first attack log set;
determining basic alarm information and interface information of an attack target corresponding to each attack log in the first attack log set, and a first attack mode of an attack event corresponding to each attack log in the first attack log set;
determining, for each attack log in the first attack log set, an attack type of the attack log according to the first attack mode corresponding to the attack log; and
inputting, for each determined attack type, basic alarm information, interface information, and the first attack mode corresponding to each attack log belonging to the attack type in the first attack log set and a model prompt into a first large language model to obtain a first attack behavior analysis report corresponding to the attack type, wherein the model prompt comprises at least one of an attack analysis prompt, a danger analysis prompt, or an output style prompt, and the first attack behavior analysis report comprises an attack behavior analysis result of at least one attack event of the attack type.

15. The electronic device of claim 14, wherein determining the first attack mode of the attack event corresponding to each attack log in the first attack log set comprises:
obtaining, for each attack log, current label information of the attack log, wherein the current label information is configured to represent a non-standard attack type of the attack event corresponding to the attack log; and
determining an attack mode corresponding to the current label information as the first attack mode of the attack event corresponding to the attack log according to a pre-established correspondence between label information and attack modes.

16. The electronic device of claim 14, wherein determining the attack type of the attack log according to the first attack mode corresponding to the attack log comprises:
obtaining current label information of the attack log, wherein the current label information is configured to represent a non-standard attack type of the attack event corresponding to the attack log; and
inputting the first attack mode corresponding to the attack log and the current label information into a second large language model to obtain a standard attack type of the attack event corresponding to the attack log as the attack type of the attack log.

17. The electronic device of claim 14, wherein the attack behavior analysis result comprises address information of an attacker and user agent information; and
when the attack logs in the first attack log set belong to a plurality of attack types, the cyber attack log processing method further comprises:
determining whether attack events of different attack types belong to same attack event according to the address information of the attacker and the user agent information in the first attack behavior analysis report; and
inputting all attack behavior analysis results belonging to same attack event in the first attack behavior analysis reports into a third large language model when the attack events of different attack types belong to same attack event, so that the attack behavior analysis results of same attack event are aggregated by the third large language model according to an attack start time sequence to obtain an attack behavior aggregation result of same attack event.

18. The electronic device of claim 17, wherein the processing apparatus is further configured to:
obtain a second attack behavior analysis report in a second period of time, wherein the first attack log set comprises attack logs in a first period of time, the first period of time is a period of time of a preset duration before the current moment, the second period of time is a period of time before the first period of time, the steps of the cyber attack log processing method are executed every preset duration, and the second attack behavior analysis report comprises an attack behavior aggregation result of each attack event in corresponding period of time;
determine whether attack behavior aggregation results in the second attack behavior analysis report in the second period of time and in the second attack behavior analysis report in the first period of time belong to same attack event according to the address information of the attacker and the user agent information; and
input attack behavior aggregation results belonging to same attack event in the second attack behavior analysis report in the second period of time and in the second attack behavior analysis report in the first period of time into the third large language model when the attack behavior aggregation results in the second attack behavior analysis report in the second period of time and in the second attack behavior analysis report in the first period of time belong to the same attack event, so that the attack behavior aggregation result of the same attack event is re-aggregated by the third large language model according to the attack start time sequence.

19. The electronic device of claim 14, wherein the processing apparatus is further configured to:
determine K attack targets with the highest number of attacks from the first attack log set, wherein K≥1; and
add a high-frequency attack identification to a first attack target in the first attack behavior analysis report, wherein the first attack target is an attack target belonging to the K attack targets in the first attack behavior analysis report.

20. The electronic device of claim 14, wherein the attack behavior analysis result comprises an attack means analysis result and a danger analysis result, and at least one of an attack type, an attack stage, attack start and end time, an attack source, an attack target, or an attack purpose.
